(19) United States
(12) Patent Application Publication
(10) Pub. No.: US 2009/0084278 A1
(43) Pub. Date: Apr. 2, 2009

(54) Process for making metalized micro-embossed films

(75) Inventors: George Masi, Toms River, NJ (US); Micheal Roughton, Belle Mead, NJ (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: R Tape Corporation

(21) Appl. No.: 11/906,728

(22) Filed: Oct. 2, 2007

(51) Int. Cl. B31F 1/07

(52) U.S. Cl. 101/32

(57) ABSTRACT

The present invention provides a process for manufacturing a metalized micro-embossed plastic film using a shim made from a flexographic plate. A digital image is transferred to the flexographic plate and the flexographic plate is processed to create a shim having a raised image corresponding to the digital image. A film is embossed by extruding the film across the flexographic plate, creating a micro-embossed surface in the film. The micro-embossed surface of the film can further be metalized to enhance the visual effects of the image when viewed from the non-embossed surface of the film.

### FIELD OF INVENTION

The present invention relates to a process for manufacturing decorative films, and more particularly to a process for manufacturing metalized micro-embossed plastic films for decorative signs and the like.

### BACKGROUND OF INVENTION

Metalized micro-embossed films have long been popular for making signage or other products having special effects such as images or backgrounds that appear to be three-dimensional. Such products are used in visual communications, graphic arts, and packaging applications. These three-dimensional illusions are created by micro-embossing a texture or pattern into one side of a film, metalizing the micro-embossed side of the film, and viewing the micro-embossed metalized image from an opposite side of the film. Common examples of such images or backgrounds include silver diamond plate, galvanized steel, polished steel, polished gold, brushed steel, brushed gold, hammered leaf silver, and hammered leaf gold. Different plastic films may be embossed and metalized for making decorative signs or other products, each having its own set of physical properties and performance characteristics that are suited to particular applications.

Typically, to create a micro-embossed texture or pattern in a plastic film, a pattern is etched into a flat plate or mold, often called a hard tool or shim. The shim is usually formed from metal, such as steel, chromium steel, or other alloy, or from hard rubber. The etched shim is wrapped around a cylinder to form a cylindrical stamping die. Finally, a plastic film is fed across and pressed against the cylindrical stamping die such that the pattern is embossed into one side of the film. Embossing may be done using a hot or cold film, depending on the substrate material of the film. For example, a vinyl film is typically hot embossed and then metalized, while a polyester film is typically cold embossed after the film has already been metalized.

A disadvantage of the conventional process for making a metalized embossed film is the cost and time required to develop and create a conventional metal or hard rubber shim that is used to emboss the film. In particular, the cost and time to create a conventional shim inhibit the manufacture of metalized embossed films that are only needed in small quantities, or that are customized for particular applications or clients. Additionally, the equipment required to create a conventional shim is costly and therefore is not readily accessible to smaller companies who manufacture metalized embossed film products. Further, the need to rely on outside vendors renders it more costly and time consuming to use conventional shims, thereby decreasing the ability of smaller companies to make customized or small quantity film products.

Accordingly, it would be advantageous to provide a shim that can be made by a less costly and less time consuming process, and to further provide a process for creating a shim usable for embossing a plastic film that is less expensive and less time consuming than creating the conventional processes.

### SUMMARY OF INVENTION

The present invention provides processes for making metalized micro-embossed plastic films using a polymer shim that is quicker and less costly to produce than metal shims made using conventional processes. The shim is created from a polymer plate.

In one embodiment, the process for manufacturing a micro-embossed film includes creating a digital image, transferring the digital image onto a flexographic plate, exposing the flexographic plate to UV-A radiation, thermally developing the flexographic plate, and embossing a film by extruding the film across the flexographic plate. The micro-embossed film can further be metalized and/or coated with an adhesive film.

In another embodiment, the process for manufacturing a micro-embossed film includes creating a digital image, transferring the digital image onto a flexographic plate, exposing the flexographic plate to UV-A radiation, thermally developing the flexographic plate, and embossing a film by extruding the film across the embossing belt.

Other objects, advantages, and features of the present invention will become apparent to those skilled in the art upon reading the following detailed description, when considered in conjunction with the appended claims and the accompanying drawings briefly described below.

### BRIEF DESCRIPTION OF DRAWINGS

The accompanying drawings, which are incorporated herein and constitute a part of this specification, illustrate preferred embodiments of the invention, and together with the general description given above and the detailed description given below, serve to explain features of the invention. However, it should be understood that this invention is not limited to the precise arrangements and instrumentalities shown in the drawings.

FIG. 1A is a schematic overview of a process according to the present invention.

FIG. 1B is a schematic overview of a process according to the present invention.

FIGS. 2A-2C show exemplary patterns that can be made using a process according to the present invention, including a coarse brushed pattern, a fine brushed pattern, and a carbon fiber weave pattern.

FIG. 3 shows a cross-sectional view of a flexographic plate before image transfer.

FIG. 3A shows a cross-sectional view of a flexographic plate after image transfer.

FIG. 4 is shows a cross-sectional view of a flexographic plate after second side UV-A exposure.

FIG. 4A shows a cross-sectional view of a flexographic plate after first side UV-A exposure.

FIG. 5 show a cross-sectional view of a flexographic plate after thermal processing.

FIG. 5A shows a cross-sectional view of a flexographic plate after post-thermal processing curing.

FIG. 5B shows a cross-sectional view of a flexographic plate after post-thermal processing finishing.

FIG. 6 shows a cross-sectional view of a flexographic plate being used to emboss a film.

FIG. 6A shows a perspective view of a flexographic plate mounted to an embossing roller and a film being embossed as it passes across the flexographic plate.

FIG. 7 shows a cross-sectional view of an embossed film comprising an extruded plastic layer.

FIG. 7A shows a cross-sectional view of a metalized embossed film comprising a plastic layer and a metal layer deposited on the plastic layer.

FIG. 7B shows a cross-sectional view of a metalized embossed film coated within adhesive comprising a plastic layer, a metal layer, and an adhesive layer.

FIG. 8 shows a schematic view of a vacuum metallization chamber for metalizing a film.

FIG. 9 shows a cross-sectional view of a flexographic plate being used to emboss an embossing belt.

FIG. 10 shows a cross-sectional view of an embossing belt being used to emboss a film.

### DETAILED DESCRIPTION OF THE ILLUSTRATED EMBODIMENTS

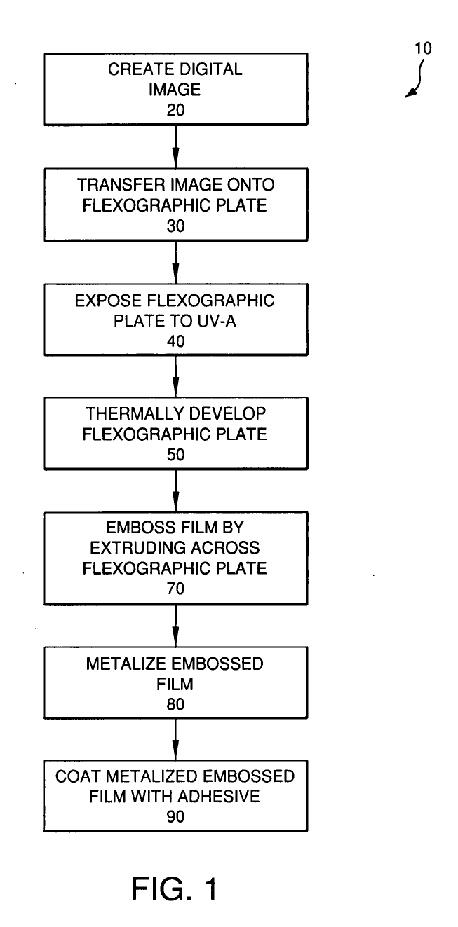

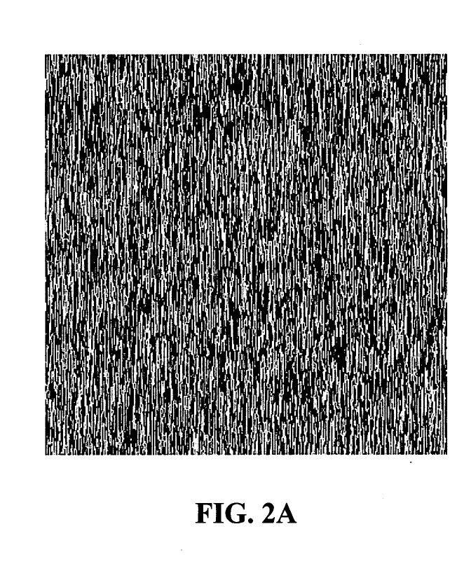

The present invention provides a process for manufacturing a metalized micro-embossed plastic film, as illustrated schematically in FIGS. 1 and 1A. Various stages of an embodiment of the process are illustrated in FIGS. 3-8, and various stages of another embodiment of the process are illustrated in FIGS. 3-5 and 7-10.

FIG. 1 depicts an embodiment 10 of the process comprising the steps of creating a digital image 20, transferring the image onto a flexographic plate 30, exposing the flexographic plate 40, thermally developing the flexographic plate 50, embossing a film by extruding the film across the flexographic plate mounted on an extruder roll 70, and metalizing the embossed film 80. The process 10 may further comprise coating the metalized embossed film with adhesive 90.

FIG. 1A depicts another embodiment 110 of the process comprising the steps of creating a digital image 120, transferring the image onto a flexographic plate 130, exposing the flexographic plate 140, thermally developing the flexographic plate 150, embossing an embossing belt by extruding the embossing belt across the flexographic plate mounted on an extruder roll 160, embossing a film by extruding the film across the embossing belt mounted on an extruder roll 170, and metalizing the embossed film 180. The process 10 may further comprise coating the metalized embossed film with adhesive 190.

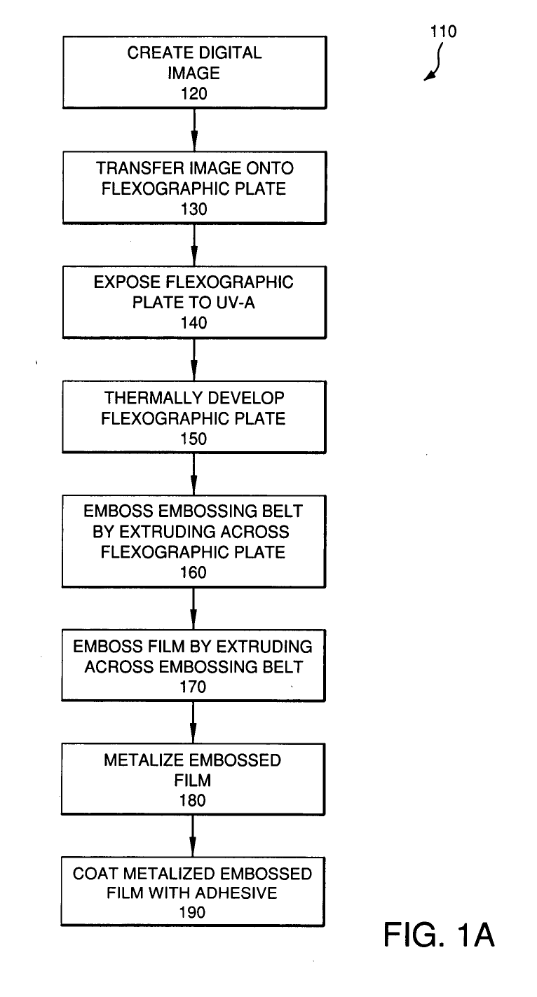

FIGS. 2A to 2C depict exemplary embodiments of metalized embossed films that can be created using an embodiment of the process described herein. For example, FIG. 2A shows a film having an image of coarse brushed pattern, FIG. 2B shows a film having an image of a fine brushed pattern, and FIG. 2C shows a film having an image of a carbon fiber weave pattern.

The embodiment 10 of the process will be described with reference to FIG. 1. In the step 20 of creating a digital image, a digital image is prepared including the desired pattern that will ultimately be embossed (and subsequently metalized) into a film. The digital image may be prepared using any standard digital design workstation or system. Such a system may be a commercially available system such as sold by Barco or Artwork Systems (e.g., PCC Artpro), or a PC-based or Macintosh-based system running a suitable design package such as Corel Draw or Adobe® Illustrator.

In subsequent steps, a flexographic plate will be used to create a shim. The flexographic plate preferably comprises a base layer made from a polymer material. Preferred flexographic plates are available from the DuPont Company and include, for example, Cyrel® DFH, a high durometer high resolution plate, and Cyrel® DFM and Cyrel® DFS, medium durometer high resolution plates. Other similar flexographic plates are available. A medium or high durometer plate can be used, depending on which resin will be used to extrude the film. The Cyrel® flexographic plates are typically sold in thicknesses of 0.045″, 0.067″, 0.100″, and 0.112″. The 0.045″ and 0.067″ thick flexographic plates are capable of being imaged to a relief depth of about 0.018″ to about 0.023″, while the 0.100″ and 0.112″ flexographic plates are capable of being imaged to a relief depth of about 0.020″ to about 0.028″. All of the plates are typically capable of retaining a minimum positive line width of about 3 mil (0.003″) and a minimum isolated dot size of about 5 mil (0.005″). The thickness and durometer rating of the plate can be selected based, at least in part, on the ability of the plate to withstand the heat generated during extrusion of the film and the effectiveness of the extrusion equipment in controlling the interface surface temperature between the plate and the extruded film.

With reference to FIG. 3, a flexographic plate 200 is preferably a photopolymer plate that comprises a polymer layer 220 having a first side 222 and a second side 224, and further comprises a mask layer 210 protecting the first side 222 from light exposure. The mask layer 210 is sensitized to laser light such that it can be selectively etched or ablated by a laser beam. The step 30 of transferring the image onto the flexographic plate 200 is described with reference to FIG. 3A. The digital image is etched into the mask layer 210 using a laser, preferably a fiber laser, to ablate or remove a portion of the mask layer 210 corresponding to the image. The remaining mask layer 210 is essentially a negative of the image, covering (i.e., protecting from light exposure) the portion of the flexographic plate 200 that will eventually be removed to a depth from the first side 222 to form a relief image in the plate 200. In the process 10, the etched image corresponds to the pattern that will subsequently be micro-embossed into a film.

Image transfer may be performed using any one of several commercially available machines designed for this purpose including, for example, Cyrel® Digital Imagers sold under the tradenames Spark 2120, Spare 2530, Spark 4835, Spark 4260, and Compact 4835. Such machines, are adapted to accept digital image file inputs in various formats, including, but not limited to, Adobe® Illustrator, Adobe® PostScript, Adobe® PDF, LEN, and TIFF, as well as proprietary formats such as FlexRip, CDI Spark, CDI Spark XT, and Grapholas®. These digital imagers, as well as other similar machines, typically are capable of etching images onto flexographic plates ranging between about 0.030″ and about 0.255″ in thickness. Images can typically be etched to a resolution of between about 2000 to about 4000 points per inch, with some machines being capable of enhanced resolutions up to about 8000 points per inch.

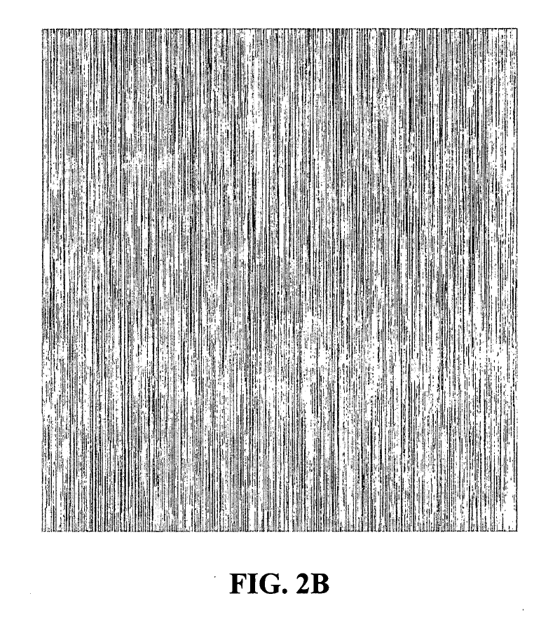

In the step 40 of exposing the flexographic plate 200, at least two operations are performed. First, as illustrated in FIG. 4, the second side 224 of the flexographic plate 200 is exposed to ultraviolet light preferably in the UV-A range, to establish a floor for the relief image that will be formed in the plate 200. UV-A radiation exposure causes the polymer layer 220 to further polymerize, making it more resistant to elevated temperatures than a non-exposed polymer layer 220. The second side exposure time varies according to the relief desired in the flexographic plate 200: shorter second side exposure times will provide for deeper relief while longer second side exposure times will provide for shallower relief. The depth of relief in the flexographic plate also corresponds to the depth of relief that will be subsequently micro-embossed into a film. For example, if deeper relief is desired in the embossed film, the UV-A exposure time of the second side 224 will be relatively short. In contrast, if shallower relief is desired in the embossed film, the UV-A exposure time of the second side 224 will be relatively long.

Next, as illustrated in FIG. 4A, the first side 222 of the flexographic plate 200 is exposed to ultraviolet light preferably in the UV-A range, preferentially exposing raised portions of the plate 200 corresponding the image that was etched away from the mask layer 210. The time of UV-A exposure of the first side 222 must complement the time of UV-A exposure time of the second side 224 so that the portion of polymer exposed from the first side 222 is of sufficient depth to join the portion of polymer exposed from the second side, as illustrated. For example, if the UV-A exposure time of the second side 224 is relatively short, to create a deeper relief, the UV-A exposure time of the first side 222 must be relatively long. Conversely, if the UV-A exposure time of the second side 224 is relatively long, to create a shallower relief, the UV-A exposure time of the first side 222 need only be relatively short.

The properties of the polymer layer 220 are such that absent exposure to UV-A radiation (e.g., the portion of the polymer layer 220 shielded from the UV-A radiation by the presence of the mask layer 210), the polymer can be removed by being melted or vaporized or sublimated by exposure to heat (i.e. infrared radiation). However, after exposure to UV-A radiation, the polymer is resistant to heat and substantially retains its solid shape and form when exposed to heat below the level sufficient to melt or vaporize polymer that was not UV-A irradiated. Non-exposed polymer is typically melted or vaporized at temperatures exceeding about 200° F., while exposed polymer is typically resistant to melting or vaporization at temperatures up to about 375° F. The mask layer 210 is similarly subject to melting or vaporization when exposed to heat sufficient to melt or vaporize the non-exposed polymer layer 220 but below that at which the exposed polymer layer 220 could be subject to melting or vaporization. Irradiation of the flexographic plate 200 with UV-A light may be performed using a commercially available machine such as those sold by the DuPont Company as the Cyrel® 1000 EC/LF and Cyrel® 2000 EC/LF.

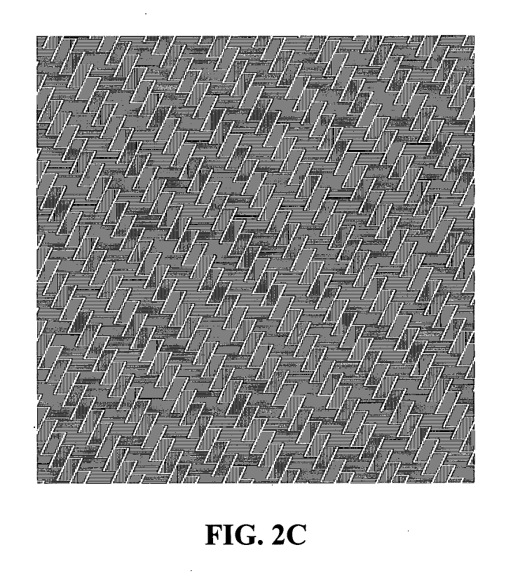

In the step 50 of thermally developing the flexographic plate 200, at least one and as many as three operations are typically performed. First, as shown in FIG. 5, the first side 222 of the plate 200 is exposed to thermal energy or infrared radiation sufficient to cause the remaining mask layer 210 and the polymer layer 220 not exposed to UV-A radiation to melt or vaporize, while allowing the polymer layer 220 exposed to UV-A radiation to remain intact. Second, as shown in FIG. 5A, it may be desirable to expose the remaining plate 200 to a further dose of UV-A radiation to eliminate surface tackiness. Third, as shown in FIG. 5B, it may further be desirable to expose the remaining plate 200 to a dose of UV-C radiation to ensure complete polymerization of the polymer layer 210 of the flexographic plate 200. Thermal developing and post processing of the plate 200 may be performed by a commercially available machine, such as those sold by the DuPont Company as Cyrel® FAST 1000TD and Cyrel® FAST TD4260.

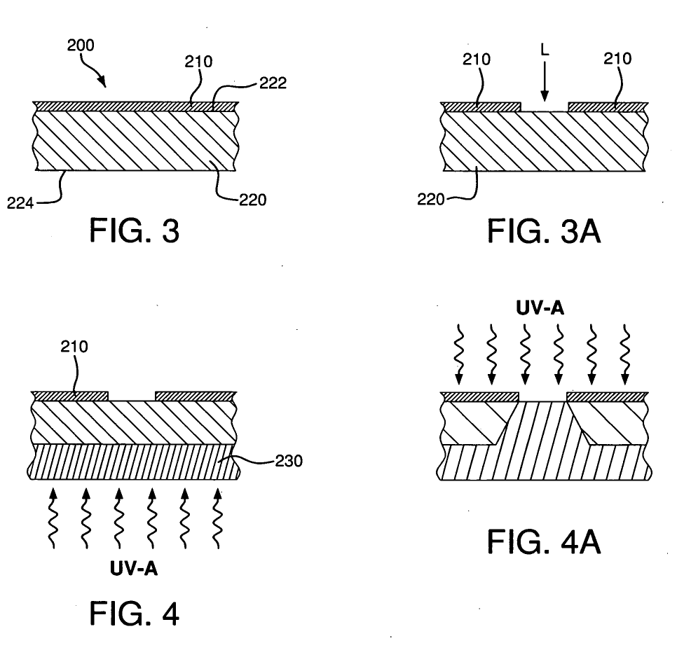

In the step 70 of embossing film, an extruded plastic film 300 comprising a layer of plastic material 310 is embossed with an imprint of the image that was formed in the flexographic plate 200. As shown in FIG. 6, the flexographic plate 200 is mounted onto a cylindrical embossing roller 250, and the film 300 is passed between the plate 200 and an opposed roller 260 that presses the film 300 against the plate 200, forcing the image to be imprinted into one surface 312 of the film 300, while the other surface 314 of the film 300 remains flat and smooth as a printable surface. The temperature at which the plastic film 300 is embossed ranges from about 350° F. to 550° F., depending on the resin from which the film is made. For example, a PVC film will be embossed at approximately 375° F., while a polycarbonate film will be embossed at approximately 525° F. The speed at which the plastic film 300 is extruded depends ranges from about 10 to 125 feet per minute, depending on film thickness. For example, a 2 mil thick film may be extruded at approximately 120 feet per minute while a 20 mil thick film may be extruded at approximately 14 feet per minute.

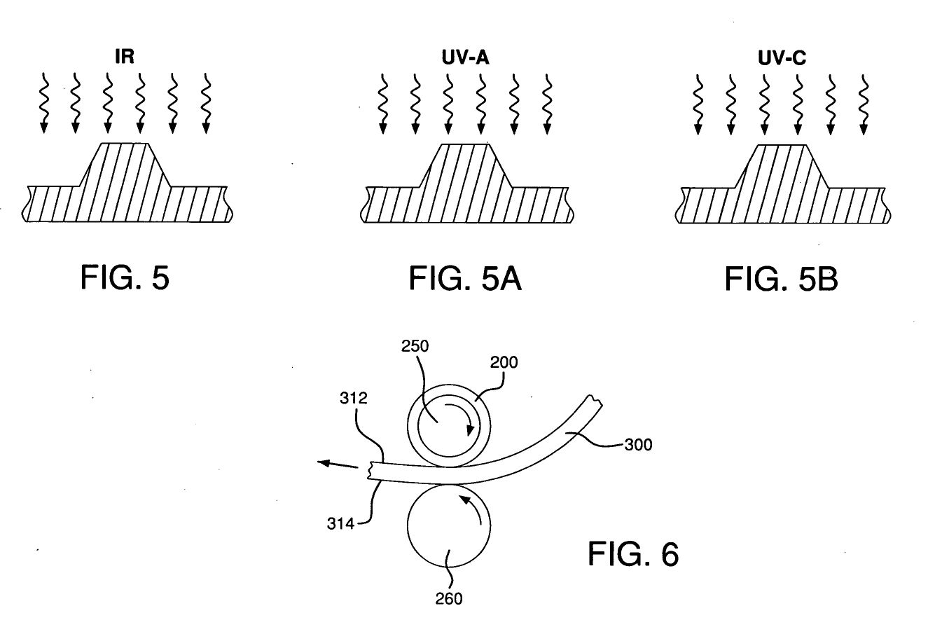

Because the flexographic plate 200 does not have the same level of surface smoothness as a conventional shim, the resultant embossed film 300 has a slightly less smooth surface than that embossed using a conventional shim. Such a film is ideally suited for films that do not require a high gloss finished pattern, such as simulated metallic surfaces. The depth and quality of the embossed image can be controlled by multiple parameters, including but not limited to temperature and pressure. In one example, if the temperature is increased, a deeper embossed image is created, and conversely, if the temperature is decreased, a shallower embossed image is created. In another example, if the embossing roll applies greater pressure to the film, a deeper embossed image is created, and if the embossing roll applies less pressure to the film, a shallower embossed image is created. It is important that the printable surface 314 is not deformed so that it can be printed with colors or inks as desired. A film 300 that has been imprinted in this manner is termed “micro-embossed” or “coined” to indicate that a three-dimensional image has been made on one surface of the film 300 to create the micro-embossed surface 312. A micro-embossed plastic layer 310 of film 300 is shown in FIG. 7.

The layer of plastic material 310 of the film 300 may be made from various materials, including, but not limited to, acrylics, polycarbonates, polyethylenes, polypropylenes, polystyrenes, copolyesters, glycol-modified polyethylene terephthalate (PETG), polyvinylchloride (PVC), polylactide (PLA), vinyl, and polyester. The film preferably is made from a thermoplastic such as vinyl or a thermoset such as polyester. Thermoplastics like vinyl, acrylic, polycarbonate, polyethylene, polylactide, and polypropylene, can be heated and extruded into a thin film. Typically, the film is about 20 mils thick. An extruded thin film made from a thermoplastic such as vinyl can be heated to a temperature at which it is malleable (or held at the same temperature at which it has just been extruded into a film) and embossed on one side by pressing that side against the flexographic plate 200. When a vinyl film is embossed by the plate 200, the film is concomitantly further extruded to a thickness of about 2.8 mils, and the imprinted image is typically between about 2 microns (0.08 mils) and about 3 mils in depth, depending upon the image requirements and the thickness of the film. An advantage of hot embossing is that the resulting imprint is deeper and thus creates a visually impressive image when metalized.

Not all films are hot embossed. Thermoset films such as polyester films, in contrast to thermoplastic films such as vinyl films, are cold embossed after the film has already been metalized. Thermoset materials start out as liquids and are cured with heat to become solid films. Once a thermoset film is cured, it cannot be reheated to be reformed. However, thermoset films are harder, more durable, and more resistant to chemicals than thermoplastic films. The finished thickness of a thermoset film such as a polyester film is typically in the range of about 0.5 mils to about 5 mils, and images imprinted on such films are typically between about 2 microns (0.08 mils) and about 3 mils in depth.

In the step 80, the embossed plastic layer 310 of the film 300 is metalized. Metalization is preferably done using aluminum, because aluminum is capable of creating a shiny mirror-like layer and also because a thin layer of aluminum is sufficiently ductile to flex along with the plastic film 300 without peeling or cracking away. About 90% of metallization is currently preformed using aluminum. Gold may similarly be used, because it possesses similar reflective and ductility properties as aluminum. Also, other metals may be used for metalizing an embossed film, such as zinc sulfate having a high refractive index.

Prior to metalizing, the micro-embossed surface 312 of the plastic layer 310 of the film 300 may be subjected to a pretreatment, such as corona treatment or plasma treatment in a vacuum chamber to increase the surface energy of the film. Corona treatment is a process whereby the material being treated is exposed to an electrical discharge or corona. Among other effects, free oxygen radicals created within the discharge area react with the material surface, creating a more bondable surface. Additionally, corona treatment may cause micropitting in the surface, increasing surface area for adherence of a metal layer and/or printing ink. An increased surface energy on the micro-embossed surface 312 permits the aluminum to more easily wet out and form a uniform layer of metal 320 that adheres to the plastic layer 310. Additionally, applying corona treatment to the plastic layer 310 of the film 300 can increase the surface energy on the printable surface 314 of the plastic layer 310, making the printable surface 314 more receptive to printing ink.

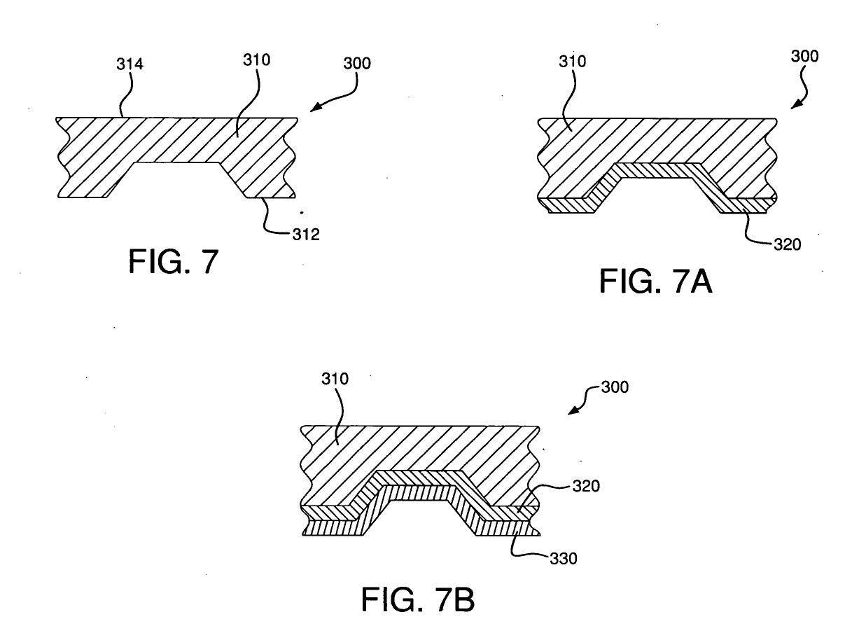

As shown in FIG. 7A, metalization applies a thin layer of metal 320 to the embossed surface 312 of the plastic layer 310. The thin layer of metal 320 acts like a mirror in reflecting light and creating special illusionary effects, when the film 300 is viewed from the printable surface 314. For forming the metal layer 320, various methods may be used. A preferred method is vacuum metallization, which is capable of depositing a thin and uniform metal coating onto the plastic layer 310, thus forming a thin uniform metal layer 320. In vacuum metallization, the embossed plastic layer 310 is passed through a vacuum chamber 350 where a metal (e.g., aluminum or gold) is evaporated. The vacuum chamber 350 illustrated schematically in FIG. 8 typically operates at pressures below about 70 millitorr (0.0013536 psia or 9.3326 pascals), and temperatures of up to 3000° F. As the plastic layer 310 passes through the low pressure metal vapors, the micro-embossed surface 312 is exposed while the printable surface 314 is chilled, typically by being in contact with a cooling drum 340 or other cooling surface. The metal vapors condense onto the micro-embossed surface 312 of the plastic layer 310, forming the metal layer 320. The thickness of the metal layer 320 is controlled by regulating several parameters including, but not limited to, the rate at which metal is vaporized, the pressure in the chamber, the temperature of the chamber, the temperature of the cooling drum, and the rate at which the film 300 is passed through the chamber.

The thickness of the metal layer 320 is typically in the range of about one to three millionths of an inch. The visual effects created by the metal layer 320 can be adjusted by varying the thickness of the metal layer 320. A thicker layer of metal is relatively opaque, whereas a thinner layer of metal is relatively transparent. For example, thinner metal layers are commonly used on products such as window films, where some amount of transparency is desired, but thicker metal layers are commonly used on such products as decorative films where opacity improves the visual effects.

After metallization, the film 300 comprises two layers, a plastic layer 310 and a metal layer 320, as shown in FIG. 7A. In the step 90, the film may further be coated with an adhesive layer 330 (or protective layer 330) disposed on top of the metal layer 320, as shown in FIG. 7B. If unprotected, the metal layer 320 can be susceptible to abrasion, oxidation, and corrosion. Accordingly, the adhesive layer 330 serves at least two purposes. First, the adhesive layer 330 serves to protect the metal layer 320 from the atmosphere and from physical contact with substances that could cause abrasion, oxidation, and/or corrosion. Second, the adhesive layer 330 provides a means for adhering the film 300 to a surface where it is to be displayed. If the film 300 will not be adhered to a surface, the metal layer 320 should still be protected with a protective layer 330 to shield the metal layer 320 from atmospheric or physical harm.

An alternate embodiment 110 of the process will be described with reference to FIG. 1A. In the step 120 of creating a digital image, a digital image is prepared including the desired pattern that will ultimately be embossed (and subsequently metalized) into a film. The digital image may be prepared using any standard digital design workstation or system, as discussed above.

In subsequent steps, a flexographic plate will be used to create a shim, which is used to create an embossing belt for embossing a film. The flexographic plate preferably comprises a base layer made from a polymer material. Preferred flexographic plates are available from the DuPont Company, as discussed above. Other similar flexographic plates are available.

With reference to FIG. 3, a flexographic plate 200 is preferably a photopolymer plate that comprises a polymer layer 220 having a first side 222 and a second side 224, and further comprises a mask layer 210 protecting the first side 222 from light exposure. The mask layer 210 is sensitized to laser light such that it can be selectively etched or ablated by a laser beam. The step 130 of transferring the image onto the flexographic plate 200 is described with reference to FIG. 3A. The digital image is etched into the mask layer 210 using a laser, preferably a fiber laser, to ablate or remove a portion of the mask layer 210 corresponding to the image. The remaining mask layer 210 is essentially a negative of the image, covering (i.e., protecting from light exposure) the portion of the flexographic plate 200 that will eventually be removed to a depth from the first side 222 to form a relief image in the plate 200. In the process 110, the etched image corresponds to the negative of the pattern that will subsequently be micro-embossed into a film. Image transfer may be performed using any one of several commercially available machines designed for this purpose, as discussed above.

In the step 140 of exposing the flexographic plate 200, at least two operations are performed. First, as illustrated in FIG. 4, the second side 224 of the flexographic plate 200 is exposed to ultraviolet light preferably in the UV-A range, to establish a floor for the relief image that will be formed in the plate 200. UV-A radiation exposure causes the polymer layer 220 to further polymerize, making it more resistant to elevated temperatures than a non-exposed polymer layer 220. The second side exposure time varies according to the relief desired in the flexographic plate 200: shorter second side exposure times will provide for deeper relief while longer second side exposure times will provide for shallower relief. The depth of relief in the flexographic plate also corresponds to the depth of relief that will be subsequently micro-embossed into a film. For example, if deeper relief is desired in the embossed film, the UV-A exposure time of the second side 224 will be relatively short. In contrast, if shallower relief is desired in the embossed film, the UV-A exposure time of the second side 224 will be relatively long.

Next, as illustrated in FIG. 4A, the first side 222 of the flexographic plate 200 is exposed to ultraviolet light in the UV-A range, preferentially exposing raised portions of the plate 200 corresponding the image that was etched away from the mask layer 210. The time of UV-A exposure of the first side 222 must complement the time of UV-A exposure time of the second side 224 so that the portion of polymer exposed from the first side 222 is of sufficient depth to join the portion of polymer exposed from the second side, as illustrated. For example, if the UV-A exposure time of the second side 224 is relatively short, to create a deeper relief, the UV-A exposure time of the first side 222 must be relatively long. Conversely, if the UV-A exposure time of the second side 224 is relatively long, to create a shallower relief, the UV-A exposure time of the first side 222 need only be relatively short.

The properties of the polymer layer 220 are such that absent exposure to UV-A radiation (e.g., the portion of the polymer layer 220 shielded from the UV-A radiation by the presence of the mask layer 210), the polymer can be removed by being melted or vaporized or sublimated by exposure to heat (i.e. infrared radiation). However, after exposure to UV-A radiation, the polymer is resistant to heat and substantially retains its solid shape and form when exposed to heat below the level sufficient to melt or vaporize polymer that was not UV-A irradiated. Non-exposed polymer is typically melted or vaporized by temperatures exceeding about 200° F., while exposed polymer is typically resistant to melting or vaporization at temperatures up to about 375° F. The mask layer 210 is similarly subject to melting or vaporization when exposed to heat sufficient to melt or vaporize the non-exposed polymer layer 220 but below that at which the exposed polymer layer 220 could be subject to melting or vaporization. Irradiation of the flexographic plate 200 with UV-A light may be performed using a commercially available machine, as discussed above.

In the step 150 of thermally developing the flexographic plate 200, at least one and as many as three operations are typically performed. First, as shown in FIG. 5, the first side 222 of the plate 200 is exposed to thermal energy or infrared radiation sufficient to cause the remaining mask layer 210 and the polymer layer 220 not exposed to UV-A radiation to melt or vaporize, while allowing the polymer layer 220 exposed to UV-A radiation to remain intact. Second, as shown in FIG. 5A, it may be desirable to expose the remaining plate 200 to a further dose of UV-A radiation to eliminate surface tackiness. Third, as shown in FIG. 5B, it may further be desirable to expose the remaining plate 200 to a dose of UV-C radiation to ensure complete polymerization of the polymer layer 210 of the flexographic plate 200. Thermal developing and post processing of the plate 200 may be performed by a commercially available machine, as discussed above.

In contrast to the embodiment 10 of the process, the embodiment 110 of the process includes a step of making an embossing belt as an intermediate shim for transferring the image from the flexographic plate shim to a film. An embossing belt is typically between 1200 yards and 2500 yards in length and allows the production of large quantities of embossed film while minimizing the wear and tear to which the flexographic plate shim is exposed, thus prolonging the usable life of the shim. The embossing belt is preferably comprised of a material having made of a hard, more heat stable material than the film to be embossed. For example, for embossing a PVC film, the embossing belt can be made from polycarbonate. An embossing belt is typically about 4 mils to 5 mils in thickness, and the embossed images is the same depth as that desired on the receiving film.

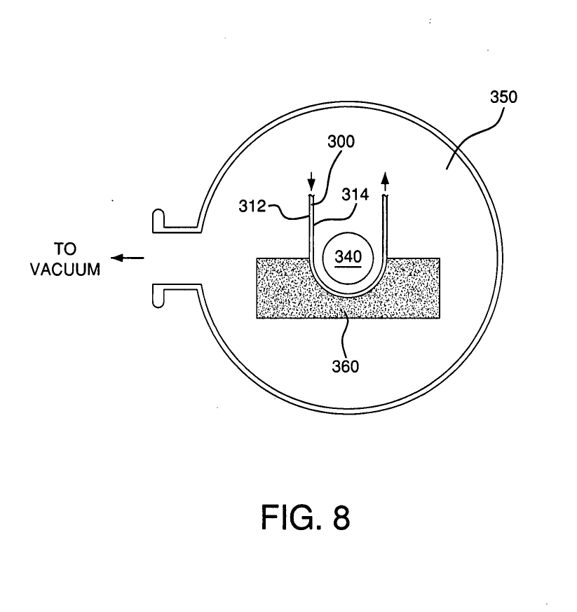

In the step 160 of embossing an embossing belt, a belt of plastic material 380 is embossed with an imprint of the image that was formed on the flexographic plate 200. As shown in FIG. 9, the flexographic plate 200 is mounted onto a cylindrical embossing roller 250 and the belt 380 is passed between the plate 200 and an opposed roller 260 that presses the belt 380 against the plate 200, forcing the image to be imprinted onto one surface 382 of the belt 380. Thus, the surface 382 of the belt 380 is micro-embossed with a three-dimensional image.

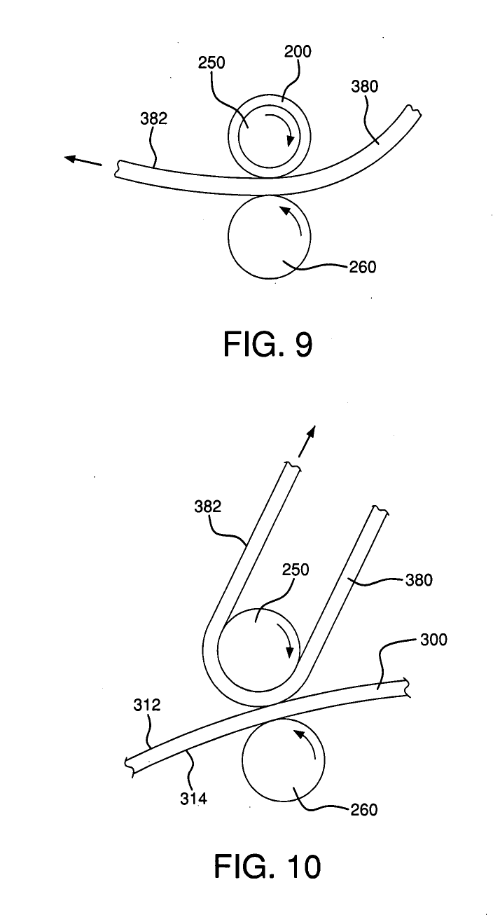

In the step 170 of embossing film, an extruded plastic film 300 comprising a layer of plastic material 310 is embossed with an imprint of the image that was formed in the embossing belt 380. As shown in FIG. 10, the embossing belt 380 is routed across a cylindrical embossing roller 250, and the film 300 is passed between the belt 380 and an opposed roller 260 that presses the film 300 against the micro-embossed surface 382 of the belt 380, forcing the image to be imprinted into a surface 312 of the film 300, while the other surface 314 of the film 300 remains flat and smooth as a printable surface. Thus, the surface 312 of the film 300 is micro-embossed with a replica of the image that was formed in the flexographic plate shim 200. It is important that the printable surface 314 is not deformed so that it can be printed with colors or inks as desired. A micro-embossed plastic layer 310 of film 300 is shown in FIG. 7. The micro-embossed surface 312 created by the embossing belt 380 in the process 110 is comparable in quality, depth, clarity, and resolution of image to the micro-embossed surface 312 created by the plate 200 in the process 10, except that the process 110 creates a replica of the image formed in the flexographic plate 200 while the process 10 creates a negative of that image.

In the step 180, the embossed plastic layer 310 of the film 300 is metalized. Metalization is preferably done using aluminum, but can also be done with gold or other metals having the required properties, as described above. Prior to metalizing, the micro-embossed surface 312 of the plastic layer 310 of the film 300 may be subjected to a pretreatment, such as corona treatment to increase the surface energy of the film.

As shown in FIG. 7A, metalization applies a thin layer of metal 320 to the embossed surface 312 of the plastic layer 310. The thin layer of metal 320 acts like a mirror in reflecting light and creating special illusionary effects, when the film 300 is viewed from the printable surface 314. For forming the metal layer 320, various methods may be used. A preferred method is vacuum metallization, which is capable of depositing a thin and uniform metal coating onto the plastic layer 310, thus forming a thin uniform metal layer 320. In vacuum metallization, the embossed plastic layer 310 is passed through a vacuum chamber 350 where a metal (e.g., aluminum or gold) is evaporated. The vacuum chamber 350 illustrated schematically in FIG. 8 typically operates at pressures below about 70 millitorr (0.0013536 psia or 9.3326 pascals), and temperatures of up to 3000° F. As the plastic layer 310 passes through the low pressure metal vapors, the micro-embossed surface 312 is exposed while the printable surface 314 is chilled, typically by being in contact with a cooling drum 340 or other cooling surface. The metal vapors condense onto the micro-embossed surface 312 of the plastic layer 310, forming the metal layer 320. The thickness of the metal layer 320 is controlled by regulating several parameters including, but not limited to, the rate at which metal is vaporized, the pressure in the chamber, the temperature of the chamber, the temperature of the cooling drum, and the rate at which the film 300 is passed through the chamber.

The thickness of the metal layer 320 is typically in the range of about one to three millionths of an inch. The visual effects created by the metal layer 320 can be adjusted by varying the thickness of the metal layer 320. A thicker layer of metal is relatively opaque, whereas a thinner layer of metal is relatively transparent. For example, thinner metal layers are commonly used on products such as window films, where some amount of transparency is desired, but thicker metal layers are commonly used on such products as decorative films where opacity improves the visual effects.

After metallization, the film 300 comprises two layers, a plastic layer 310 and a metal layer 320, as shown in FIG. 7A. In the step 190, the film may further be coated with an adhesive layer 330 (or protective layer 330) disposed on top of the metal layer 320, as shown in FIG. 7B. If unprotected, the metal layer 320 can be susceptible to abrasion, oxidation, and corrosion. Accordingly, the adhesive layer 330 serves at least two purposes. First, the adhesive layer 330 serves to protect the metal layer 320 from the atmosphere and from physical contact with substances that could cause abrasion, oxidation, and/or corrosion. Second, the adhesive layer 330 provides a means for adhering the film 300 to a surface where it is to be displayed. If the film 300 will not be adhered to a surface, the metal layer 320 should still be protected with a protective layer 330 to shield the metal layer 320 from atmospheric or physical harm.

While the invention has been disclosed with reference to certain preferred embodiments, numerous modifications, alterations, and changes to the described embodiments are possible without departing from the sphere and scope of the invention, as defined in the appended claims and equivalents thereof. Accordingly, it is intended that the invention not be limited to the described embodiments, but that it have the full scope defined by the language of the following claims.

We claim:

1. A process for manufacturing a micro-embossed film comprising:
creating a digital image;
transferring the digital image onto a flexographic plate;
exposing the flexographic plate;
thermally developing the flexographic plate; and
embossing film by extruding the film across the flexographic plate.

2. The process of manufacturing a micro-embossed film of claim 1, further comprising metalizing the embossed film.

3. The process of manufacturing a micro-embossed film of claim 2, further comprising applying an adhesive to the metalized embossed film.

4. The process of manufacturing a micro-embossed film of claim 1, further comprising applying an adhesive to the embossed film.

5. The process of manufacturing a micro-embossed film of claim 1, wherein the flexographic plate comprises a mask layer and a plastic layer, and wherein the transferring step comprises ablating an image in the mask layer corresponding to the digital image.

6. The process of manufacturing a micro-embossed film of claim 5, wherein the exposing step comprises irradiating a first side of the flexographic plate with ultraviolet light in the UV-A range and irradiating a second side of the flexographic plate with ultraviolet light in the UV-A range.

7. The process of manufacturing a micro-embossed film of claim 6, wherein the thermally developing step comprises heating the first side of the flexographic plate to remove the mask layer and the portion of the plastic layer underlying the mask layer that was not irradiated with UV-A light.

8. The process of manufacturing a micro-embossed film of claim 1, wherein the embossing step comprises mounting the flexographic plate to a cylindrical embossing roller and extruding the film between the flexographic plate and an opposed roller.

9. The process of manufacturing a micro-embossed film of claim 1, wherein the embossing step comprises:
mounting the flexographic plate to a cylindrical embossing roller and extruding an embossing belt between the flexographic plate and an opposed roller, and
routing the embossing belt across a cylindrical embossing roller and extruding the film between the embossing belt and an opposed roller.

10. The process of manufacturing a micro-embossed film of claim 2, wherein the film comprises a thermoplastic film, the embossing step comprises hot extruding the film, and the metalizing step follows the embossing step.

11. The process of manufacturing a micro-embossed film of claim 2, wherein the film comprises a thermoset film, the embossing step comprises cold extruding the film, and the metalizing step precedes the embossing step.

12. A process for manufacturing a micro-embossed film comprising:
creating a digital image;
transferring the digital image onto a flexographic plate;
exposing the flexographic plate;
thermally developing the flexographic plate;
creating an embossing belt by extruding the embossing belt across the flexographic plate; and
embossing film by extruding the film across the embossing belt.

13. The process of manufacturing a micro-embossed film of claim 12, further comprising metalizing the embossed film.

14. The process of manufacturing a micro-embossed film of claim 13, further comprising applying an adhesive to the metalized embossed film.

15. The process of manufacturing a micro-embossed film of claim 12, further comprising applying an adhesive to the embossed film.
